(19) United States
(12) Patent Application Publication
(10) Pub. No.: US 2006/0277326 A1
(43) Pub. Date: Dec. 7, 2006

(54) Data transfer system and method

(75) Inventors: Vincent Tsai, Hsinchu (TW); Sheng Han Lin, Hsinchu (TW)

Correspondence Address: Haverstock & Owens LLP, 162 North Wolfe Road, Sunnyvale, CA, 94086, US

(73) Assignee: Accusys, Inc.

(21) Appl. No.: 11/447,355

(22) Filed: Jun. 5, 2006

(30) Foreign Application Priority Data
Jun. 6, 2005 (TW) 094118657

(51) Int. Cl. G06F 13/28

(52) U.S. Cl. 710/22

(57) ABSTRACT

Disclosed is a low hysteresis center offset comparator, comprising a first switch device, a differential amplifier, a second switch device, a general comparator, a first inverter and a second inverter. By means of the components, a hysteresis window with the low hysteresis center offset may be formed with respect to the inventive comparator with a width of a half-portion thereof formed equal to that of the other half-portion thereof corresponding to an offset voltage inherent in the differential amplifier.

### FIELD OF THE INVENTION

The present invention relates to a data access method. More particularly, the present invention relates to a data transfer system and method used in a computer system.

### BACKGROUND OF THE INVENTION

With development of the computer, computer use chip manufacturers are always seeking for controllers having more rapid operation speed and better efficiency. As a matter of fact, data access speed is a critical factor with respect to the computer efficiency issue. The overall performance of the computer can not be promoted without a proper data access architecture although the most advanced processing chip is provided. Further, since the multiplexity operation scheme has been largely used in the computer and the computer has been widely used for communication applications, there is a larger and larger demand placed on data transfer in the computer field.

Generally, an interface controller is usually relied upon when data is to be transferred from one computer system to another. Such interface controller is typically connected with a host memory via a system bus (e.g. a PCI bus). The interface controller may make a request from the host system for access of the system bus for a data transfer task. When the access of the system bus is acquired, the interface controller can access the system memory. In other words, the interface controller can transfer data from/to the system memory in response to a data transfer request.

Direct memory access (DMA) technology is a frequently used data transfer technique in the computer system, where a DMA controller is served as the interface controller. When it is desired to transfer data between an I/O device (e.g. a hard disk) and the system memory, the system processor transmits the addresses and byte count information associated with the to-be-transmitted data to the DMA controller. When the system bus is acquired by the DMA controller, the data transfer operation begins. Without any interrupt or error signal, the system processor does not intervene the data transfer operation conducted by the DMA controller. Accordingly, the performance of the system processor will not be reduced due to the existence of the data transfer operation.

In the conventional computer architecture, the physical space of the system memory is generally divided into a plurality of “discontinuous segments” by the operation system (OS) for the management reason. Thus, the to-be-transferred data has to be divided into a plurality of discontinuous data blocks before they are written into the memory. In response to this, a scatter/gather based data transfer mechanism is generally used so that the data write operation can be finished. In doing this, a procedure of compiling a scatter/gather table has to be executed first, wherein the scatter/gather table is composed of a plurality of objects, each comprises information about the source addresses and destination addresses and the byte count associated with the data transfer operation. The compiled scatter/gather table is generally stored in the system memory and the DMA controller directs the data transfer operation to proceed based on the compiled scatter/gather table.

However, the data transfer operation may have a poor efficiency in some situations due to the poor efficiency scatter/gather table compiling. For example, the total source memory space and the total destination memory space arranged for the transferred data before the data transfer operation have to be equal in amount. However, the memories of the source end and the destination end are not necessarily the same type, such as DRAM and hard disk. Although the DRAM and the hard disk may both be divided into discontinuous fragments, the space suitable to be used to store data and the space allot scheme in the two kinds of memory are generally not identical to each other in the two memory types. In the case that the total numbers of the discontinuous fragments in the source end and the destination end are not equal to each other, the time required for compiling the scatter/gather table is prolonged, reducing the data transfer performance.

To overcome the demerits mentioned in the above, the present invention discloses a data transfer system and method in which a dual scatter/gather table is involved and a particular control mechanism is used to control the compiling of the dual scatter/gather table.

### SUMMARY OF THE INVENTION

In accordance with an aspect of the present invention, a data transfer system is disclosed, which comprises a host processor establishing a first control information in response to a data transfer request of an executed program by the data transfer system, a host memory connected to the host processor and a bus via an interface controller to store the first control information, and an I/O controller connected to the bus to acquire the first control information and comprising a local processor establishing a second control information comprising a plurality of objects and corresponding to the first control information after the I/O controller receives the first control information, a local memory storing the second control information, and a DMA controller transferring the data according to the first and second control information.

In a prefer embodiment, the first control information comprises a plurality of objects each corresponding to a respective one of a plurality of data blocks of data associated with the data transfer request.

In a preferred embodiment, each of the first and second control information is a scatter/gather table.

In a preferred embodiment, the I/O controller is a redundant array of independent disks (RAID) control card.

In accordance with another aspect of the present invention, a data transfer method executed on a data processing system is disclosed, which comprises an I/O controller having a local processor and a local memory, a host processor and a host memory is disclosed, which comprises the steps of (a) sending out a data transfer request from an executed program by the host processor, (b) establishing a first control information, (c) storing the first control information in the host memory, (d) establishing a second control information comprising a plurality of objects and corresponding to the first control information in response to the first control information, and (e) transferring the data between the local memory and the host memory according to the first and second control information.

In a preferred embodiment, the I/O controller further comprises a DMA controller.

In a preferred embodiment, the first control information comprises a plurality of objects each corresponding to a respective one of a plurality of data blocks of data associated with the data transfer request.

In a preferred embodiment, the step (e) further comprises the steps of (e1) executing the respective ones of the plurality of objects of the first control information in order, (e2) gathering the respective ones of the plurality of data blocks corresponding to the respective objects of the first information in order to form an information flow in a First In First Out (FIFO) manner, and (e3) scattering the information flow to respective destination addresses each assigned by the respective one of the plurality of objects of the second control information.

In a preferred embodiment, the plurality of objects of the first control information are equal to the plurality of objects of the second control information in amount.

In a preferred embodiment, the plurality of objects of the first control information are different from the plurality of objects of the second control information in amount.

In a preferred embodiment, each of the first and second control information is a scatter/gather table.

In a preferred embodiment, each of the plurality of objects of the first and second control information includes a source, a destination and a byte count of the corresponding data block.

In a preferred embodiment, the I/O controller is a redundant array of independent disks (RAID) control card.

Other objects, advantages and efficacies of the present invention will be described in detail below taken from the preferred embodiments with reference to the accompanying drawings.

### BRIEF DESCRIPTION OF THE DRAWINGS

The foregoing summary, as well as the following detailed description of the preferred embodiments, is better understood when read in conjunction with the appended drawings. It is understood, however, that the invention is not limited to the specific methods and disclosed or illustrated. In the drawings:

FIG. 1 is a system architecture diagram of a data transfer system according to the present invention, in which a dual scatter/gather table is relied upon for data block transfer;

FIG. 2 is an illustrative diagram illustrating how discontinuous data blocks are transferred in the data transfer system shown in FIG. 1 according to the present invention; and

FIG. 3 is a flowchart illustrating a data transfer method performed based on the dual scatter/gather table according to the present invention.

### DETAILED DESCRIPTION OF THE PREFERRED EMBODIMENT

The present invention discloses a data transfer system and method, which will be described through the preferred embodiments with reference to the appended drawings.

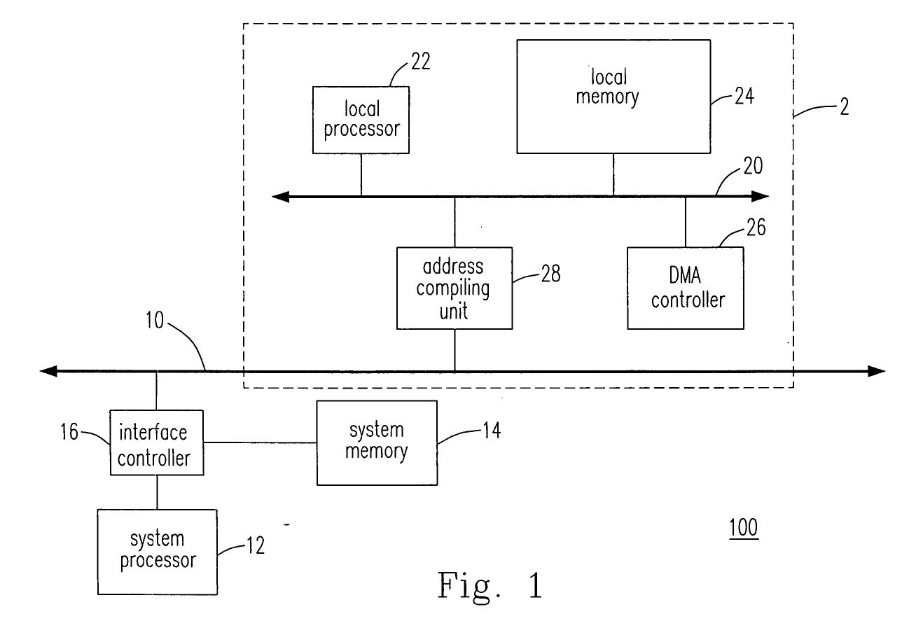

Referring to FIG. 1, a system architecture diagram of a data transfer system according to the present invention is shown therein. The data transfer system 100 comprises a system processor 12, a system memory 14 and an I/O controller 2. The system processor 12 establishes a first control information in response to a data transfer request made by an operating system (OS) when a program is executed on the data transfer system. The data transfer request is made for requesting discontinuous data blocks in a memory at a source end to be transferred to a memory block at a destination end, particularly where discontinuous memory fragments are presented, wherein the memory block at the source end has a beginning memory address and an ending memory address and the destination end has a beginning memory address and an ending memory address. The system memory 14 is connected to the system processor 12 and a system bus 10 through an interface controller 16 for storing the first control information. The I/O controller 2 is connected to the system processor 12 and the system memory 10 via the system bus 10. As also shown, the I/O controller 2 comprises a local processor 22, a local memory 24, a direct memory access (DMA) controller 26 and an address compiling unit 28, which are connected to each other via an internal bus 20. When the first control information is generated after calculation in the system processor 12, the local processor 22 in the I/O controller 2 also establishes a second control information based on the first control information. The local memory 24 is used to store the second control information. In addition, the address compiling unit 28 is used to compile the beginning and ending memory addresses of the to-be-transferred discontinuous data blocks in the source end to the beginning and ending memory addresses of the to-be-transferred discontinuous data blocks in the destination end. In a preferred embodiment, each of the first and second control information is an operating program for the data transfer generated from a calculation based on the data transfer request. Specifically, the first and second control information is presented in the form of a first and second scatter/gather tables respectively, in which a plurality of objects each corresponding to one of the to-be-transferred discontinuous data blocks are contained. The first and second scatter/gather tables are named a dual scatter/gather table herein. Each of the objects comprises information about the source end, the destination end and a byte count associated with the corresponding one of the to-be-transferred discontinuous data blocks. As such, each of the to-be-transferred discontinuous data blocks can be transferred from the source end to the destination end without the need of the controlling of the system processor 12.

In a preferred embodiment, the I/O controller 2 is a redundant array of independent disks (RAID) card having a buffer or a register. With the operation of the RAID controller card 2, an I/O device (not shown), such as a hard disk, connected to the system bus 10 may directly access the data stored in the system memory 14 via the DMA controller 26.

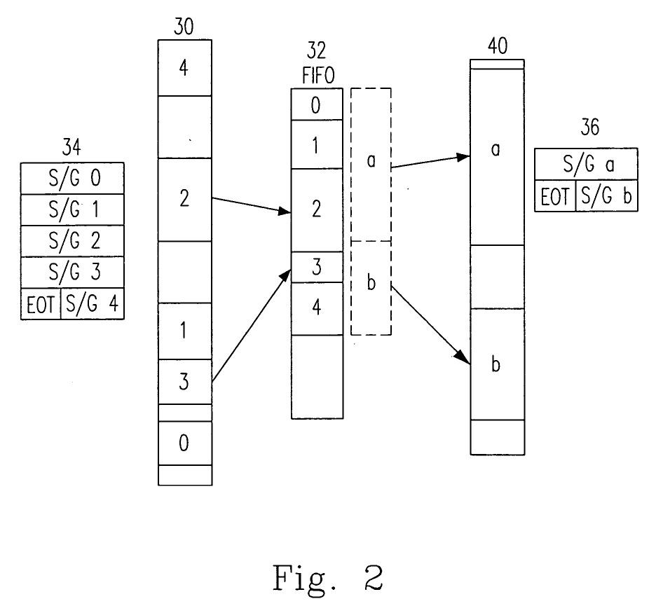

Referring to FIG. 2, an illustrative diagram illustrating how the discontinuous data blocks are transferred in the data transfer system shown in FIG. 1 according to the present invention is shown therein. In FIG. 2, a first scatter/gather table 34 is established in response to the data transfer request. The first scatter/gather table 34 includes five objects S/G0, S/G/1, . . . , S/G4. Each of the objects S/G0, S/G/1, . . . , S/G4 corresponds to one of five discontinuous data blocks 0-4 in the source memory 30 (the system memory 14 in FIG. 1 ). As mentioned above, each of the objects S/G0, S/G/1, . . . , S/G4 includes the information about the corresponding one of the discontinuous data blocks 0-4 involved in the data transfer task, comprising the beginning memory addresses and the ending memory addresses at the source end, the beginning memory addresses and the ending memory addresses at the destination end and the byte count of the discontinuous data blocks 0-4. Once the DMA controller in FIG. 1 initializes the data transfer operation, the information about the objects S/G0, S/G/1, . . . , S/G4 is loaded into a specific register of the DMA controller 26 so that each of the discontinuous data blocks 0-4 at the source end can be transferred to the destination end. When the discontinuous data blocks 0-4 are transferred, information stored in a second scatter/gather table 36 is transferred simultaneously, which is the main difference of this data transferring technology from the prior art. As noted above, the second scatter/gather table 36 is generated corresponding to the first scatter/gather table 34 and also stored in the local memory 24 of the RAID controller card 2. Likewise, objects S/Ga, S/Gb included in the second scatter/gather table 36 comprises information about the corresponding one of the discontinuous data blocks a, b involved in the data transfer task, comprising the beginning memory addresses and the ending memory addresses at the source end, the beginning memory addresses and the ending memory addresses at the destination end and the byte count of the discontinuous data blocks a, b. As shown, a data flow composed of the discontinuous data blocks a, b is a data flow composed of the discontinuous data blocks 0-4 originally stored in the source memory 30. During the time when the discontinuous data blocks 0-4 are transferred, it is executed by the DMA controller based on the objects S/G0, S/G1, . . . , S/G4 in the first scatter/gather table 34. According to the information stored in the objects S/G0, S/G1, . . . , S/G4, the beginning and ending memory addresses of the source end and the beginning and ending memory addresses of the destination end of the discontinuous data blocks are beginning and ending memory addresses of a source memory 30 and beginning and ending memory addresses of a buffer memory 32 on the RAID controller card in FIG. 1, respectively. When the discontinuous data blocks 0-4 are transferred to the buffer memory 32, the address compiling unit in FIG. 1 is used to compile the associated addresses into virtual memory addresses (shown as dotted lines) in a First In First Out (FIFO) manner. Meanwhile, the discontinuous data blocks a, b in the buffer memory 32 are transferred to the destination memory 40 at the destination addresses corresponding to the objects S/Ga, S/Gb block by block based on the information of the objects S/Ga, S/Gb in the second scatter/gather table 36. In this manner, the discontinuous data blocks can be successfully transferred from the source end to the destination end. In the first and second scatter/gather tables 34, 36, the last one of the objects (the objects S/G4 and S/Gb in the scatter/gather tables 34, 36, respectively) includes an ending bit EOT, indicating that the discontinuous data blocks corresponded by the associated scatter/gather tables have been totally transferred. Namely, when the ending bit EOT is encountered, it is indicated that the discontinuous data block transfer task associated with in the dual scatter/gather tables has been completed.

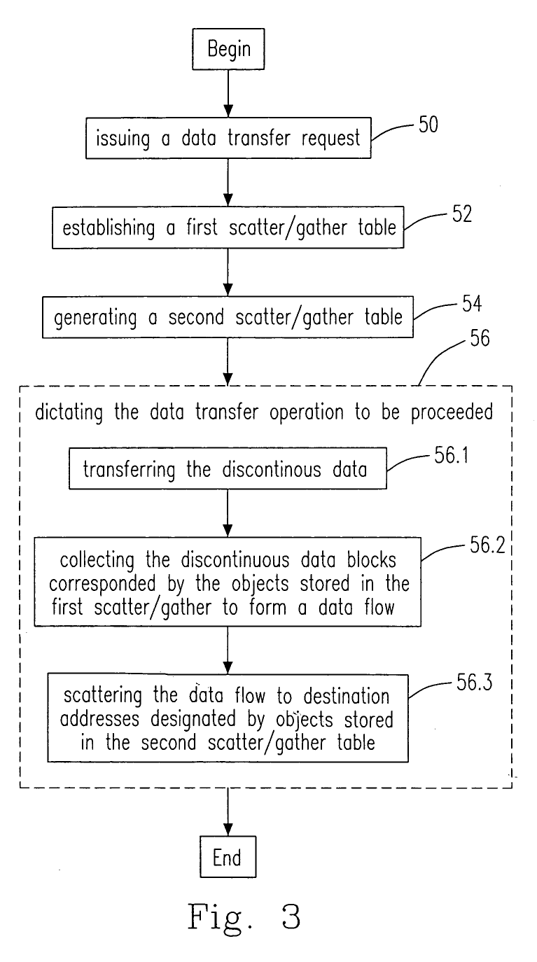

Referring to FIG. 3, a flowchart illustrating a data transfer method by using the dual scatter/gather table according to the present invention is shown therein. This data transfer method may b executed on the above described data transfer system. At first, the I/O device (such as a hard disk) issues a data transfer request by means of the operating system (OS) to transfer discontinuous data blocks (S50). Next, the system processor establishes a first scatter/gather table according to the data transfer request and stores the first scatter/gather table in the system memory (S52). Then, the local processor generates a second scatter/gather table based on the first scatter/gather table and a memory space in the destination memory (S54). Finally, the DMA controller dictates the data transfer operation to be proceeded between the I/O device and the system memory based on the first and second scatter/gather table (S56).

In an embodiment, the step S56 further comprises the following steps S56.1-S56.3. In step S56.1, the discontinuous data blocks are each transferred according to the corresponding one of the objects stored in the first scatter/gather table. In step S56.2, the discontinuous data blocks corresponded by the objects stored in the first scatter/gather table are collected to form a data flow. In step 56.3, the data flow is scattered to the destination addresses designated by objects stored in the second scatter/gather table. In this manner, different numbers of discontinuous data blocks can be transferred with the use of the dual scatter/gather table.

While the invention has been described in terms of what is presently considered to be the most practical and preferred embodiments, it is to be understood that the invention needs not be limited to the disclosed embodiments. For example, although the discontinuous data blocks are described as involved in the data transfer operation, the continuous data blocks can also be transferred to the destination end through the inventive data transfer system and method. Therefore, it is intended to cover various modifications and similar arrangements included within the spirit and scope of the appended claims, which are to be accorded with the broadest interpretation so as to encompass all such modifications and similar structures.

What is claimed is:

1. A data transfer system, comprising:
a host processor establishing a first control information in response to a data transfer request of an executed program thereby;
a host memory connected to the host processor and a bus via an interface controller to store the first control information; and
an I/O controller connected to the bus to acquire the first control information and comprising:
a local processor establishing a second control information comprising a plurality of objects and corresponding to the first control information after the I/O controller receives the first control information;
a local memory storing the second control information; and
a DMA controller transferring the data according to the first and second control information.

2. The system as claimed in claim 1, wherein the first control information comprises a plurality of objects each corresponding to a respective one of a plurality of data blocks of data associated with the data transfer request.

3. The system as claimed in claim 1, wherein each of the first and second control information is a scatter/gather table.

4. The system as claimed in claim 1, wherein the I/O controller is a redundant array of independent disks (RAID) control card.

5. A data transfer method executed on a data processing system comprising an I/O controller having a local processor and a local memory, a host processor and a host memory, comprising the steps of:
(a) sending out a data transfer request from an executed program by the host processor;
(b) establishing a first control information;
(c) storing the first control information in the host memory;
(d) establishing a second control information comprising a plurality of objects and corresponding to the first control information in response to the first control information; and
(e) transferring the data between the local memory and the host memory according to the first and second control information.

6. The method as claimed in claim 5, wherein the I/O controller further comprises a DMA controller.

7. The method as claimed in claim 5, wherein the first control information comprises a plurality of objects each corresponding to a respective one of a plurality of data blocks of data associated with the data transfer request.

8. The method as claimed in claim 7, wherein the step (e) further comprises the steps of:
(e1) executing the respective ones of the plurality of objects of the first control information in order;
(e2) gathering the respective ones of the plurality of data blocks corresponding to the respective objects of the first information in order to form an information flow in a First In First Out (FIFO) manner; and
(e3) scattering the information flow to respective destination addresses each assigned by the respective one of the plurality of objects of the second control information.

9. The method as claimed in claim 7, wherein the plurality of objects of the first control information are equal to the plurality of objects of the second control information in amount.

10. The method as claimed in claim 7, wherein the plurality of objects of the first control information are different from the plurality of objects of the second control information in amount.

11. The method as claimed in claim 7, wherein each of the first and second control information is a scatter/gather table.

12. The method as claimed in claim 7, wherein each of the plurality of objects of the first and second control information includes a source, a destination and a byte count of the corresponding data block.

13. The method as claimed in claim 7, wherein the I/O controller is a redundant array of independent disks (RAID) control card.
